(19) United States
(12) Patent Application Publication
(10) Pub. No.: US 2022/0040876 A1
(43) Pub. Date: Feb. 10, 2022

(54) Flat Die Magnetic Holding Base and Metallic, Flat Die for Use Therewith

(71) Applicant: Atlas Die, LLC, Rochester Hills, MI (US)

(72) Inventor: Sean Talkington, Elkhart, IN (US)

(73) Assignee: Atlas Die, LLC, Rochester Hills, MI (US)

(21) Appl. No.: 16/985,612

(22) Filed: Aug. 5, 2020

(51) Int. Cl. B26D 7/26; B26F 1/44

(52) U.S. Cl. CPC B26D 7/2614; B26F 1/44; B26F 2001/4463; B26F 2001/4445; B26D 2007/2607

(57) ABSTRACT

A flat die magnetic holding base is provided for holding a metallic, flat die. The base can be formed from a metal plate having a front surface and a planar back surface. The front surface can include a planar mounting area. The planar back surface can have a plurality of recesses formed therein. The metal plate has three or more corners, each corner having a through-hole formed therein. Magnets are permanently fixed in recesses formed in the back surface. The magnets are oriented in the recesses such that a magnetic field is generated by the magnets in a direction that magnetically attracts and holds a metallic, flat die, to and on, the planar mounting area. The flat die can be a magnetically-attractable, milled-plate, flexible die. Alignment pins extend away from the planar mounting area and align with through-holes of the metallic, flat die to register the metallic, flat die on the mounting area.

### FIELD OF THE INVENTION

The present invention relates to flat dies for use in a die cutter, magnetic bases for holding such dies, and alignment systems and features for aligning flat dies to bases and to counter plates.

### BACKGROUND OF THE INVENTION

Flat dies have long been used in die cutters. Typically, the flat dies comprise a retaining board having a plurality of die slots formed therein, and a plurality of die blades retained in the die slots. The die blades can be cutting blades, scoring blades, creasing blades, perforating blades, and the like, arranged in a die pattern. Unfortunately, due to the slot widths, the die rule blade widths, and the materials used for retaining boards, such flat dies cannot exhibit consistently repeatable tolerances and die cutting accuracy. Variations from cut to cut can be noticeable, undesired, and is often unacceptable. Variations in cutting precision, in the range of from ten one-thousandths to 50 one-thousandths, of an inch, are typical.

Rotary dies have also been used for a long time. Rotary dies use chemically-etched, flexible, metallic die plates that can be bent around a rotary drum. Such flexible, metallic die plates exhibit cutting features and other die-working features on the exposed, outer surface thereof, when bent around a rotary drum. Thus, rotary die systems typically do not involve die rules mounted in die slots. Unfortunately, however, the alignment of the flexible, metallic die plates on the rotary drum changes over time and use, and variations in cutting precision, in the range of from ten one-thousandths to 50 one-thousandths, of an inch, are typical.

A need exists for a die cutter system that provides very little variation in cutting precision, over time and use. It would be desirable to provide a die cutter system that exhibits variation in cutting precision, over time and use, within the range of from four one-thousandths to seven one-thousandths of an inch.

### SUMMARY OF THE INVENTION

The foregoing and other objectives are provided by the holding bases, flat dies, systems, and methods of the present invention. According to various embodiments of the present invention, a flat die magnetic holding base is provided. The magnetic holding base is configured to mount a metallic, flat die thereon, which can be magnetically held in place. The metallic, flat die can be aligned to the magnetic holding base by using a system of dowel pins protruding from the magnetic holding base, and through-holes formed in the metallic, flat die. The metal plate can have a back surface provided with a plurality of recesses formed therein for holding magnets, threaded inserts, and dowel pins. When fully assembled, magnets, threaded inserts, and dowel pins are located in the recesses. Each corner of the metal plate can have a through-hole formed therein, holding a roll pin bushing for alignment of a counterplate.

The recesses can include a plurality of first recesses, and a plurality of first magnets can be provided, for example, wherein each first recess has a first magnet permanently fixed therein. The first magnets can be held in the first recesses by a cured epoxy or by another hardenable material. Each magnet can be arranged in an orientation such that a first magnetic field is generated that magnetically attracts and holds a metallic, flat die to a flat mounting area of the magnetic holding base. The recesses can go all the way through the metal plate, or be recessed only part way through the thickness of the metal plate. At least two alignment pins can be provided that extend out of the front surface of the metal plate, away from the flat mounting area. The metallic, flat die can be mounted on the flat mounting area via engagement of the alignment pins with through-holes in the metallic, flat die.

An assembly comprising a flat die magnetic holding base as described herein, and a metallic, flat die, is also provided, wherein the metallic, flat die is magnetically held on the flat mounting area. The metallic, flat die can comprise a pattern of lands, blades, rules, or other features that extend from a front surface of the flat die. The metallic, flat die can further comprise at least two through-holes formed therethrough, into which alignment pins of the flat die magnetic holding base extend to align the metallic, flat die with the flat mounting area. The metallic, flat die can comprise a milled metal plate, for example, a chemically etched metal plate, a mechanically milled metal plate, a combination thereof, or the like.

### BRIEF DESCRIPTION OF THE DRAWINGS

The invention may be more fully understood with reference to the accompanying drawings. The drawings are intended to illustrate, not limit, the present teachings.

FIG. 1 is a bottom view of a flat die holding base in accordance with an embodiment of the present invention.

FIG. 2 is a bottom view of a flat die magnetic holding base according to an embodiment of the present invention.

FIG. 3A is an enlarged view of a corner portion of the back surface of the flat die holding base shown in FIG. 1, further including a bushing assembly in the corner recess, providing a smooth through-bore.

FIG. 3B is an enlarged view of the front surface of the flat die holding base corner portion of FIG. 3A and showing the opposite end of the bushing assembly.

FIG. 4A is a top view of the front surface of the flat die magnetic holding base of FIG. 2, showing the bearer rules and hex bushings protruding from the landings.

FIG. 4B is a top view of the flat die magnetic holding base shown in FIG. 4A, but further including elastically deformable stand-off bearers straddling the bearer rules shown in FIG. 4A.

FIG. 5 is a top view of a metallic flat die that can be aligned with and magnetically held by the flat die magnetic holding base shown in FIGS. 4A and 4B.

FIG. 6 is a side view of the flat die magnetic holding base shown in FIG. 4B, magnetically holding thereon a metallic, flat die.

FIG. 7 is a top view of another assembly according to the present invention, including a flat die magnetic holding base magnetically holding thereon a metallic, flat die.

FIG. 8 is a close-up side view of a corner of the assembly shown in FIG. 7 and further comprising a counterplate aligned with the assembly such that the roll pin shown extends from the assembly into a counterplate alignment through-hole.

FIG. 9 is a top view of a counterplate that can be aligned with a flat die magnetic holding base and with a metallic, flat die, according to various embodiments of the present invention, and shows alignment features that can be aligned with corresponding alignment features of the flat die magnetic holding base, including corresponding alignment pin features.

### DETAILED DESCRIPTION OF THE INVENTION

According to various embodiments of the present invention, a flat die magnetic holding base is provided. The holding base can comprise a metal plate having a front surface and a back surface, and the front surface includes a flat mounting area for mounting a flat die. The back surface can have a plurality of recesses formed therein for holding magnets, threaded inserts, and dowel pins. When fully assembled, magnets, threaded inserts, and dowel pins are located in the recesses. The metal plate can have three or more corners, for example, it can have a rectangular shape and four corners. Each corner can have a through-hole formed therein, extending from the front surface to the back surface. The holding base can comprise a rigid material, a metal material, a solid metal, aluminum, iron, steel, stainless steel, an alloy, a combination thereof, or the like. The plate can comprise a non-metallic material, for example, a resin, a polymer, a plastic, a wood, a Rayform Dieboard material available from Wagner Die Supply (Elmhurst Ill.), a laminate material, combinations thereof, or the like. Exceptional precision and longevity can be provided by using a metal plate, such as a plate made of solid aluminum.

The recesses can include a plurality of first recesses, and a plurality of first magnets can be provided, for example, wherein each first recess has a magnet permanently fixed therein. The first magnets can be held in the first recesses by a cured epoxy or other hardenable material. Each magnet can be arranged in an orientation such that a first magnetic field is generated that magnetically attracts and holds a metallic, flat die to the flat mounting area. The recesses can go all the way through the metal plate, or the recesses can extend 50%, 60%, 70%, 80% or 90% through the thickness of the metal plate. At least two alignment pins can be provided that extend out of the front surface and away from the flat mounting area, onto which a metallic, flat die can be mounted via engagement of the alignment pins with through-holes in the metallic, flat die.

An assembly comprising a flat die magnetic holding base as described herein, and a metallic, flat die, is also provided. The metallic, flat die can be magnetically held on the flat mounting area and can have a front surface, a die pattern on the front surface, and a flat back surface. The flat back surface can be planar. The front surface of the metallic, flat die can be planar, but for the die pattern. The flat back surface can be configured to contact the flat mounting area of the flat die magnetic holding base. The die pattern can comprise a pattern of lands, blades, rules, or other features that extend from the front surface. The metallic, flat die can further comprise at least two through-holes formed therethrough. The at least two alignment pins of the flat die magnetic holding base can extend respectively into the at least two through-holes of the metallic, flat die to align the metallic, flat die with the flat mounting area. The metallic, flat die can comprise a milled metal plate, for example, a chemically etched metal plate, a mechanically milled metal plate, a combination thereof, or the like. At least three alignment pins can be provided in the base and used with at least three through-holes in the metallic, flat die. Using three pins in three through-holes disposed in three-out-of-four corners can ensure proper directional alignment and proper alignment with a counterplate.

The flat die magnetic holding base can comprise a metal plate having a triangular shape, a square shape, a rounded shape, a polygonal shape, a rectangular shape, or any other shape. The flat die magnetic holding base can comprise a metal plate having a rectangular shape, wherein two sides of the metal plate can be parallel to each other, and two parallel edge areas can be formed in the front surface, respectively adjacent the two sides. Each of the two parallel edge areas can comprise a step and a landing. The metal plate can have a first thickness at the planar mounting area, each landing can have a second thickness, and the second thickness can be less than the first thickness, for example, 10% less, 30% less, 50% less, 60% less, 70% less, 80% less, or 90% less. In each landing a metal die rule retaining slot can be formed, or a series of metal die rule retaining slots. The slots can be configured to hold metal rules in the form of bearer rules.

The flat die magnetic holding base can further comprise a plurality of metal die rule holding magnet recesses formed in the back surface of the metal plate, and the plurality can include at least one metal die rule holding magnet recess adjacent each metal die rule retaining slot. A plurality of second magnets can be provided, including a second magnet permanently fixed in each metal die rule holding magnet recess. Each of the second magnets can be arranged in an orientation such that a second magnetic field is generated that magnetically holds a metal die rule in the respective, adjacent, metal die rule retaining slot. The second magnetic field can be oriented perpendicular relative to the first magnetic field. A plurality of metal die rules can be provided, including a respective metal die rule in each metal die rule retaining slot. A plurality of second magnetic fields can be provided, and the second magnetic fields can be oriented parallel to one another, with each also being perpendicular to the first magnetic field.

Each of the first magnets can have a flat surface and the flat surfaces of the first magnets can all be arranged parallel to one another. Each of the second magnets can have a flat surface and the flat surfaces of the second magnets can be oriented perpendicularly with respect to the flat surfaces of the first magnets. Either or both of the first magnets and the second magnets can comprise permanent magnets, rare earth permanent magnets, neodymium magnets, NdFeB magnets, or the like. Each of the first magnets can be disk-shaped and permanently fixed in a respective one of the first recesses, by a hardened epoxy.

Each landing can comprise two through-hole bushings for holding roll pins for alignment purposes, to align a counterplate. The roll pins can be held by friction, one in each of the two bushing through-holes. The flat die magnetic holding base can be combined with a counterplate having counterplate through-holes, and each roll pin can be held by friction in a respective one of the counterplate through-holes for a one-time alignment process. The back of the counterplate can be spray-coated with adhesive, or adhesive can otherwise be applied thereto, and the holding force of the adhesive can be greater than the force holding the roll pins in the through-holes of the counterplate. Upon a first pressing in a die cutter, the counterplate can thus be adhered to a chase or platen of the die cutter while remaining aligned with the metallic, flat die magnetically held on the flat mounting area.

For holding the metallic, flat die to the flat mounting area, at least two alignment pins can be used, each received in a respective alignment pin through-hole formed in the metal plate. Each of the at least two alignment pins can have an outer diameter, each of the alignment pin through-holes can have an inner diameter, and the outer diameter and the inner diameter can be the same. With no space between the alignment pins and the alignment pin through-holes, a very tight, friction fit results when the alignment pins are hammered or otherwise pressed into the alignment pin through-holes. Similarly, the through-holes of the counterplate snuggly receive the alignment pins when the metallic, flat die is placed on the flat mounting area and the alignment pins of the base and the through-holes of the counterplate are aligned.

According to various embodiments, a method of making an assembly as described herein is also provided. The method can comprise placing a metallic, flat die as described herein on the flat mounting area such that the flat die magnetic holding base magnetically holds the metallic, flat die. The method can involve positioning the metallic, flat die such that at least two alignment pins extend into at least two alignment pin through-holes of the metallic, flat die. Further, the method can involve removing the metallic, flat die from the flat mounting area. A different metallic, flat die can then be placed on the flat mounting area such that the flat die magnetic holding base magnetically holds the different metallic, flat die, and such that the at least two alignment pins of the holding base extend into at least two through-holes of the different metallic, flat die.

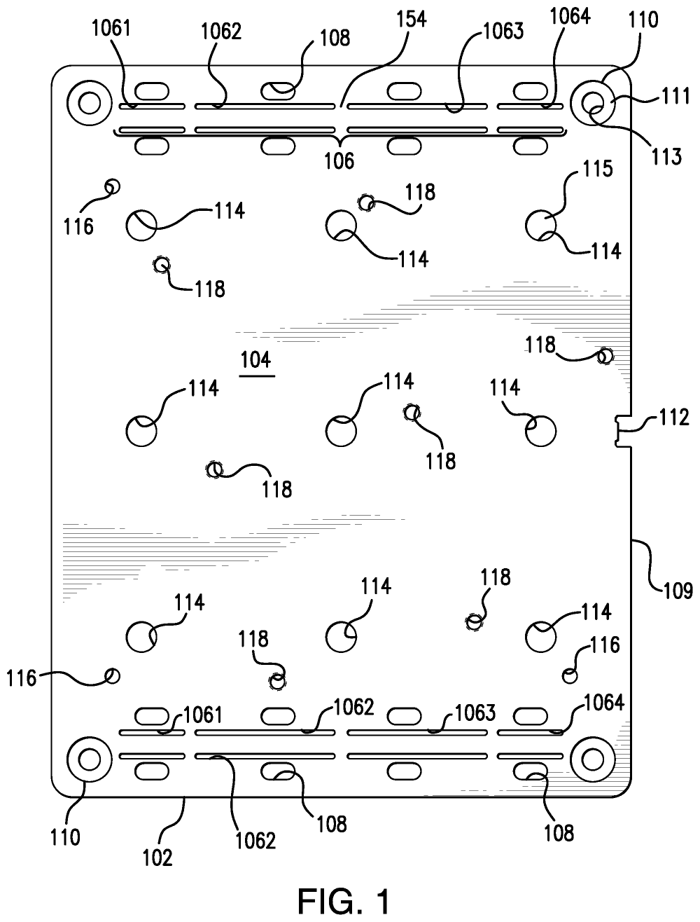

With reference now to the drawings, FIG. 1 is a bottom view of a flat die holding base 102, according to various embodiments of the present invention. Flat die holding base 102 can be made out of a metal material, for example, aluminum, iron, steel, stainless steel, carbon spring steel, an alloy, an iron alloy, an aluminum alloy, a filled material, or the like. The back side of flat die magnetic holding base 102 is shown in FIG. 1 as 104. Bearer rule receiving slots 106 are provided, formed in base 102, and each bearer rule receiving slot includes interruptions along a length thereof, in the form of bridges 154. Each bearer rule receiving slot 106 comprises four, linearly aligned sub-slots 1061, 1062, 1063, and 1064 that are spaced apart from one another along a length direction, by bridges 154. Bearer rule magnet receiving slots 108 are provided, one adjacent each sub-slot 1061, 1062, 1063, and 1064. Zero, one, or more bearer rule magnet receiving slots 108 can be provided adjacent each sub-slot 1061, 1062, 1063, and 1064. One or more bearer rule magnet receiving slots 108 can be provided adjacent the entirety of composite slot 106.

A recess 110, including a shoulder 111 and a through-hole 113 are provided in each corner of flat die holding base 102, for receiving a registration pin. One or more registration pins can be used to register flat die magnetic holding base 102 with a counterplate. A die cutter chase alignment notch 112 is provided along leading edge 109 of flat die holding base 102. Flat die holding base 102 can be bolted to a die cutter using bolts engaged with threaded inserts tapped into planar back surface 104.

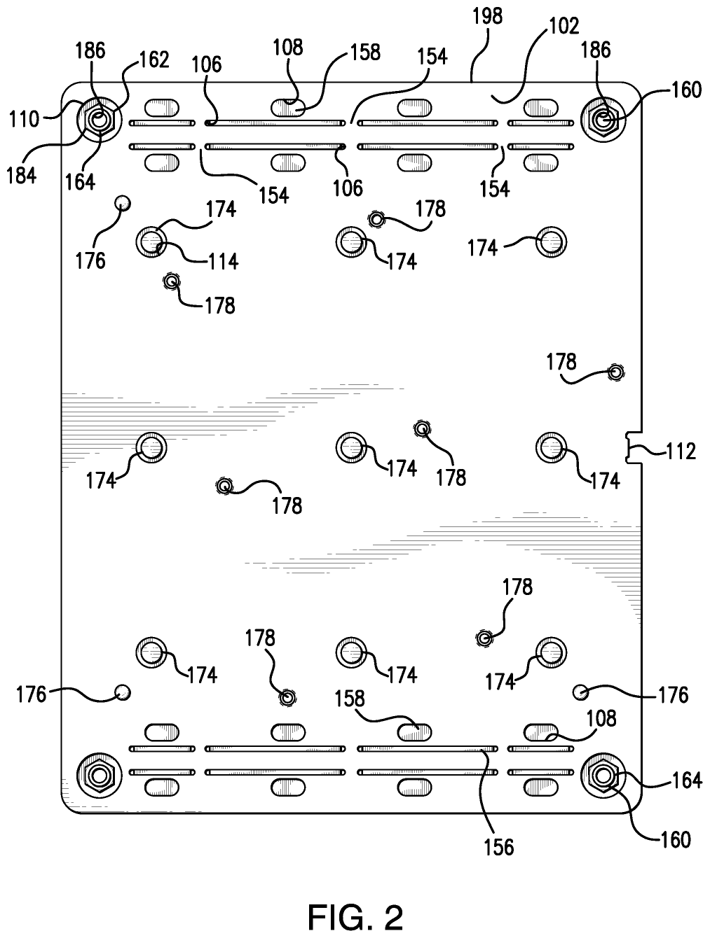

As further shown in FIG. 1, recesses 114 are provided in back side 104 for embedding flexible die holding magnets 174, as shown in FIG. 2, to form a flat die magnetic holding base. Through-holes 116 are provided for receiving alignment pins or dowels useful for maintaining a flexible die aligned on a planar mounting area on a front surface 105 of flat die holding base 102. As also seen in FIG. 1, threaded recesses 118, that have been tapped into planar back surface 104, are provided for receiving a threaded insert, for example, a dual-threaded key-locking threaded insert. Exemplary of such threaded inserts is the KEYSERT® insert available form Recoil Quality Thread Insert Systems of Bangalore, India. To further exemplify such inserts, an 8 mm insert length can be used, an M8×1.25 external thread size can be used, an M4×0.70 internal thread size can be used, or the like. Stainless steel inserts, for example, with a passivated finish, a Grade 303, or both, can be used. The inserts can be arranged so that two or more of them lines-up with and can receive anchoring bolts for mounting base 102 on a die cutter, a die cutter chase, a die cutter platen, or the like.

FIG. 2 is a similar view to that of FIG. 1, but shows magnets, pins, bushings, and rules inserted into the various recesses, through-holes, and slots of flat die holding base 102 shown in FIG. 1, to form a flat die magnetic holding base. FIG. 2 also shows bridges 154 along bearer rule receiving slot 106, separating each bearer rule receiving slot 106 into sub-slots 1061, 1062, 1063, and 1064. As seen in FIG. 2, a steel bearer rule 156 is received in receiving slot 106. The back edge of steel bearer rule 156 is shown in FIG. 2, and the front edge, or working edge, of steel bearer rule 156 can comprise a cutting edge, a creasing edge, a perforating edge, a scoring edge, a combination of edges, an intermittent edge finish, or the like. Steel bearer rules 156 are magnetically held in respective receiving slots 106 by one or more bearer rule magnets 158 in one or more respective bearer rule magnet receiving slots 108. Bearer rule magnets 158 can be embedded in hardened or cured epoxy in bearer rule magnet receiving slots 108 and thus permanently fixed in the back side 104 of flat die holding base 102. Curable epoxies or other hardenable resins can be used. When magnets are embedded in flat die holding base 102, as shown in FIG. 2, the holding base can then also be referred to as flat die magnetic holding base. FIG. 2 also shows dual-threaded key-locking threaded inserts 178 threaded into threaded recesses 118 (FIG. 1). Dual-threaded key-locking threaded inserts 178 can be configured and sized to receive mounting bolts to fasten flat die magnetic holding base 102 onto a die cutter chase, such as a Bobst chase available from Bobst Group North America Inc., of Little Switzerland, N.C. Exemplary mounting bolts that can be used include M4×12 metric flat head cap screws, or the like.

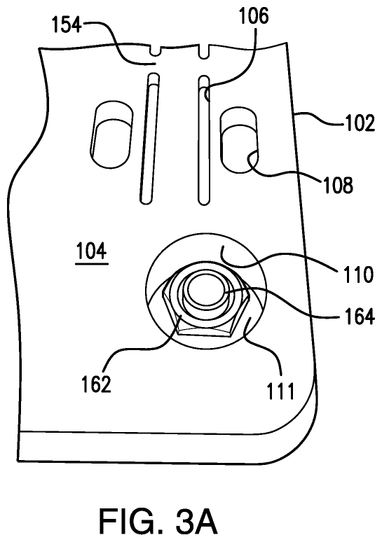

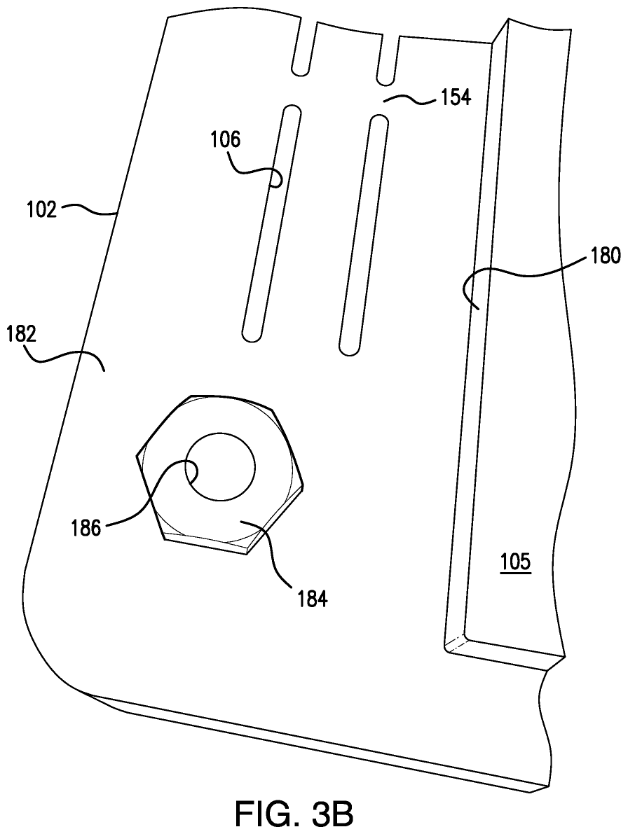

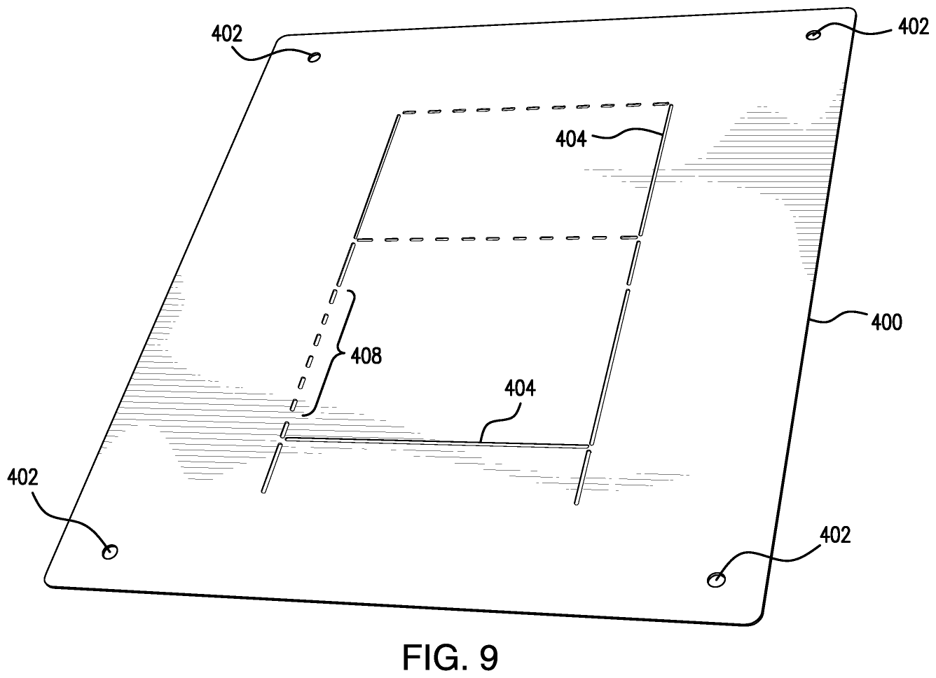

As shown in FIGS. 3A and 3B, a registration pin bushing assembly 160 can be provided in two or more corners of the flat die magnetic holding base 102, for example, in each corner of flat die magnetic holding base 102. A hex nut 162 (FIG. 3A) that is part of bushing assembly 160 can be configured to engage and hold a hex bushing 184 (FIG. 3B) onto flat die magnetic holding base 102. Hex bushing 184 includes a smooth through-bore 186 formed through the center of a stem 164 of hex bushing 184. Smooth through-bore 186 is configured to snuggly receive a roll pin, for example, to facilitate aligning a counterplate with flat die magnetic holding base 102. Smooth through-bore 186 is configured to receive a roll pin that can be used to align a counterplate (FIG. 9) with flat die magnetic holding base 102, and thus also to align the counterplate with a metallic, flat die held on flat die magnetic holding base 102. Stem 164 is hollow and defines smooth through-bore 186. Stem 164 has outer threads that are configured to engage with the threads of hex nut 162, and are shown engaged with the threads of hex nut 162 to hold hex bushing 184 in place on flat die magnetic holding base 102.

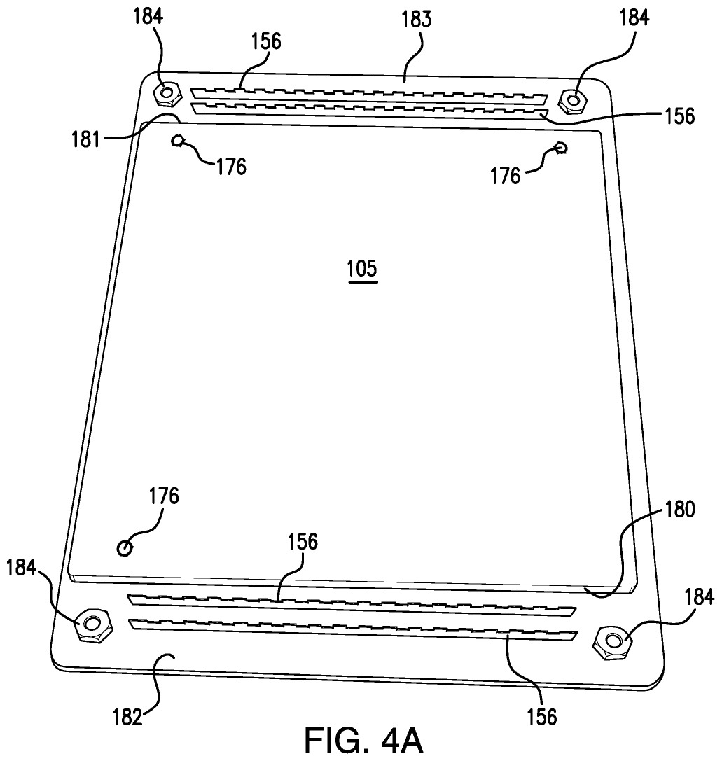

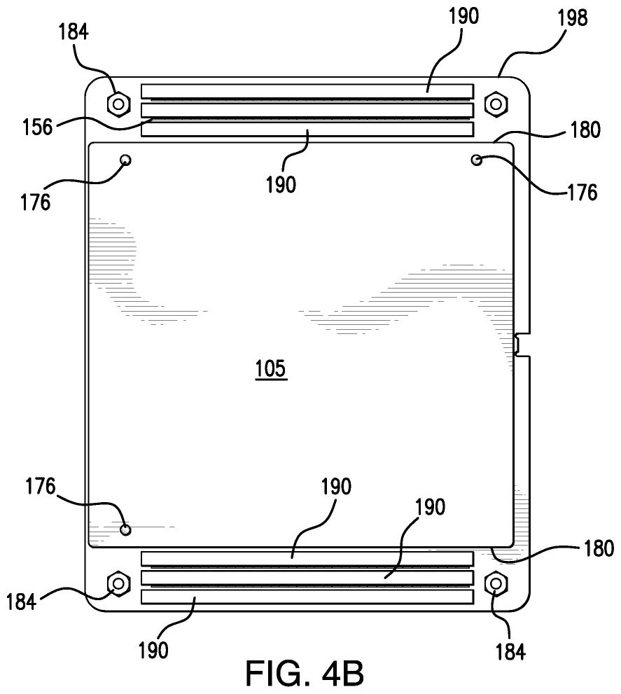

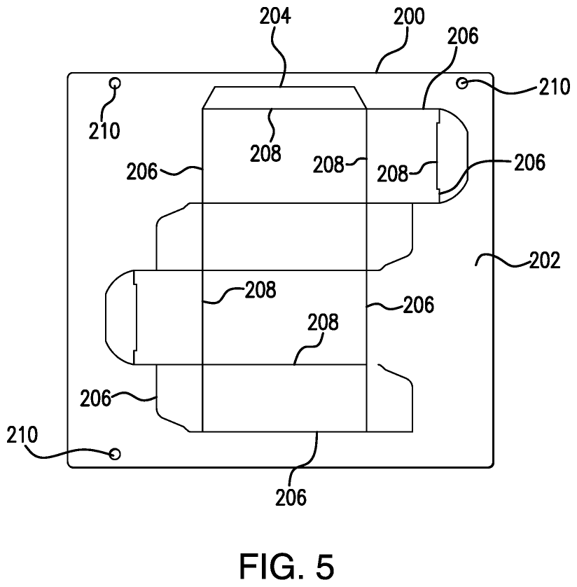

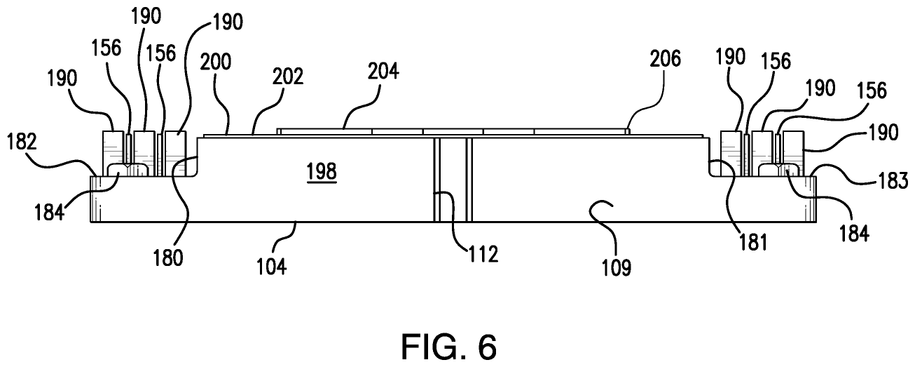

As shown in FIGS. 4A and 4B, steel dowel pins 176 can be provided in flat die magnetic holding base 102, slightly protruding and extending away from front surface 105 of a central die mounting area of flat die magnetic holding base 102. Steel dowel pins 176 can be used for registering a flexible die 200 (FIGS. 5 and 6) onto flat die magnetic holding base 102.

FIGS. 3B, 4A, 4B, and 6 show a step 180 provided between front surface 105 of flat die magnetic holding base 102, and a landing 182 of flat die magnetic holding base 102. Step 180 forms an intersection between front surface 105 and landing 182, as best seen in FIGS. 4A and 6. Similarly, a step 181 is provided at the intersection of front side 105 and landing 183, also as shown in FIGS. 4A and 6. FIGS. 4B and 6 also show elastically deformable stand-off bearers, or ejection material, 190, straddling steel die rules 156. Stand-off bearers 190 can comprise elastically deformable, rubber ejection material. As can be seen in FIG. 6, the top surfaces of elastically deformable stand-off bearers 190 and the distal edges of steel die rules 156 rise slightly above the top or front surface 105 of flat die magnetic holding base 102.

FIG. 5 is a top view of a metallic, flat die that can be used with and magnetically held to the flat die magnetic holding base shown in FIGS. 2, 4A, and 4B. As shown in FIG. 5, metallic, flat die 200 has a top surface 202 having formed thereon a die cutting pattern 204 made of die working lands, including cutting lands 206 and creasing lands 208. The lands can be milled, for example, by chemical milling or mechanical milling, or three-dimensionally printed. Three alignment holes 210 are formed through metallic, flat die 200 and are configured to align with and receive steel dowel pins 176 shown in FIGS. 4A and 4B. Metallic, flat die 200 is aligned with assembled flat die magnetic holding base 198 (FIG. 6) via the engagement of steel dowel pins 176 in alignment holes 210. Metallic, flat die 200 is magnetically held to assembled flat die magnetic holding base 198 (FIG. 6) via the plurality of metallic, flat die holding magnets 174 shown in FIG. 2, that are embedded in base 102 with an epoxy or other hardenable resin.

The various die working lands of metallic, flat die 200 can be in the form of cutting lands, perforating lands, scoring lands, creasing lands, or the like. The lands can be formed by chemically etching a flexible die substrate, by using, for example, acid etching, ferric chloride, photoresist layers and patterns, and the like, or by mechanical milling, or by 3-D printing. The lands can be formed to develop a die pattern, for example, from a carbon spring steel or a stainless steel flexible die substrate. The devices methods, systems, and materials described in U.S. Pat. No. 3,850,059 to Kang and U.S. Patent Application Publication No. US 2004/0040365 A1 to Misaki can be used, for example, to form the flexible dies useful according to the present invention.

FIG. 6 is a side view of a fully assembled flat die magnetic holding base 198 having a metallic, flat die 200 aligned therewith and magnetically held thereon. Although not drawn to scale, the relative thicknesses of the components are generally accurate and show that metallic, flat die 200 is very thin compared to assembled flat die magnetic holding base 198. As shown in FIG. 6, metallic, flat die 200 has a top surface 202 and a pattern of die working lands in the form of cutting lands 206 and creasing lands 208 that are shown in FIG. 5. From the side view of FIG. 6, only cutting lands 206 can be seen. The other features shown in FIG. 6 are the same features as those shown and described in connection with FIGS. 3B, 4A, and 4B.

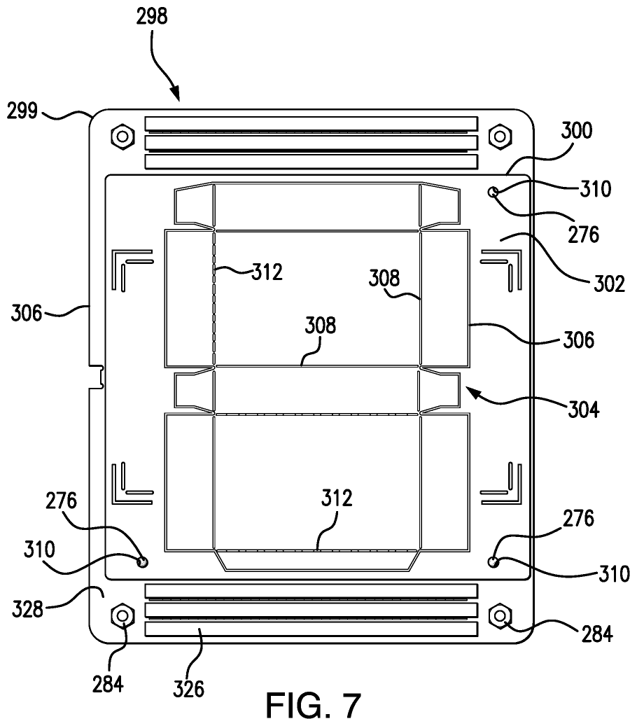

FIG. 7 is a top view of another assembly 298 according to the present invention, including a flat die magnetic holding base 299 magnetically holding thereon a metallic, flat die 300. Metallic flat die 300 is aligned with flat die magnetic holding base 299 and magnetically held thereon. As shown in FIG. 7, metallic, flat die 300 has a top surface 302 and a pattern 304 of die working lands in the form of cutting lands 306, creasing lands 308, and perforating lands 312. Three alignment pin through-holes 310 are provided through metallic, flat die 300. Steel dowel pins 276 are provided in flat die magnetic holding base 299 extending away from the front surface of flat die magnetic holding base 299, and slightly protruding from the front surface of a central die mounting area of flat die magnetic holding base 299. Three steel dowel pins 276 can be seen received in three respective alignment pin through-holes 310 provided in metallic, flat die 300, thus registering metallic, flat die 300 with flat die magnetic holding base 299 and forming assembly 298. For the alignment of assembly 298 with a counterplate (not shown), four corner hex bushings 284 are provided in the landings of flat die magnetic holding base 299, including two corner hex bushings in landing 328.

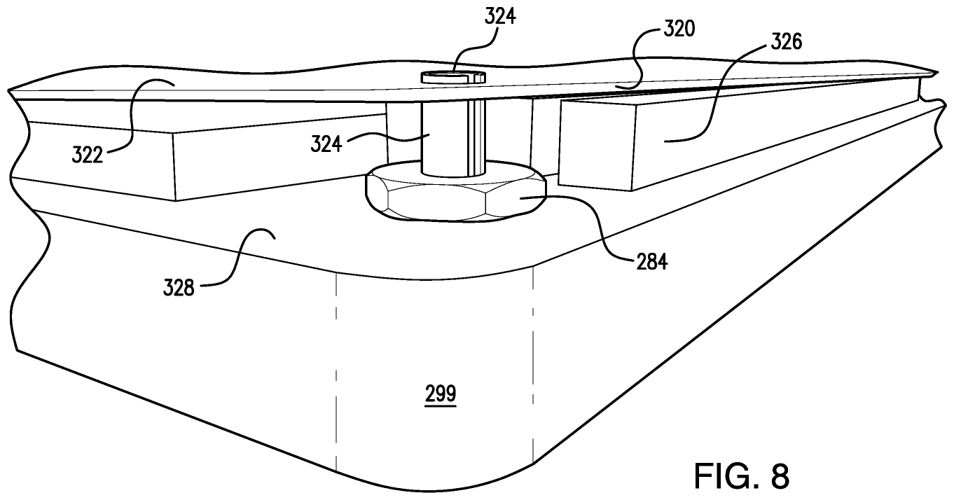

FIG. 8 is a close-upside view of a corner of assembly 298 shown in FIG. 7, further including a counterplate 320 aligned with assembly 298. Counterplate 320 includes a bonding surface 322 onto which an adhesive is applied. Upon an initial pressing in a die cutter, the adhesive will bond bonding surface 322 of counterplate 320 onto a platen or chase of the die cutter. Due to the flat die magnetic holding base 299 being bolted to an opposing platen or chase of the die cutter, the flat die magnetic holding base and counterplate will initially be aligned with one another and remain that way through many pressings of the die cutter. A roll pin 324 can be seen held in a smooth through-bore of hex bushing 284. Roll pin 324 can be seen extending from flat die magnetic holding base 299 up to and through counterplate through-hole 310 (FIG. 7). By using four such arrangements of bushings, roll pins, and counterplate through holes, counterplate 320 can be precisely aligned with flat die magnetic holding base 299, in the die cutter. An outer strip of ejection rubber 326 is also seen in FIG. 8.

As seen in FIG. 9, a counterplate 400 that can be used with and according to embodiments of the present invention, includes a plurality of counterplate registration through-holes 402 configured to align with and receive roll pins that are held in hex bushings of a cooperating flat die magnetic holding base (not shown). Counterplate registration holes 402 can be used to align the counterplate with the flat die magnetic holding base, for example, with assembled base 198 shown in FIG. 6 or with any of the flat die magnetic holding bases described herein. Accordingly, the counterplate can thereby also be aligned with a metallic, flat die, as described herein, held on the flat die magnetic holding base. According to embodiments of the present invention, aligned assemblies and methods of making and using them are also provided.

FIG. 9 shows counterplate die receiving grooves 404 that can be configured to receive the working edge of a die working land or die working rule. Counterplate die receiving grooves 404 can take the form, for example, of a perforate counterplate receiving groove 408 for receiving a perforating land, perforating die blade, or perforating die rule.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such a range is separately disclosed. Where a range of numerical values is recited herein, unless otherwise stated, the range is intended to include the endpoints thereof, and all integers and fractions within the range. It is not intended that the scope of the invention be limited to the specific values recited when defining a range.

All patents, patent applications, and publications mentioned herein are incorporated herein in their entireties, by reference, unless indicated otherwise.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A flat die magnetic holding base comprising:
a metal plate having a front surface and a back surface, the front surface including a flat mounting area, the back surface having a plurality of first recesses formed therein, the metal plate having three or more corners, each corner having a through-hole formed therein and extending from the front surface to the back surface;
a plurality of first magnets, each first recess having a respective one of the first magnets permanently fixed therein, each first magnet being arranged in an orientation such that a first magnetic field is generated that magnetically attracts and holds a metallic, flat die to the flat mounting area; and
at least two alignment pins that extend out of the front surface and away from the flat mounting area.

2. An assembly comprising the flat die magnetic holding base of claim 1 and further comprising a metallic, flat die magnetically held on the flat mounting area, the metallic, flat die having a front surface, a die pattern on the front surface, and a flat back surface, the flat back surface contacting the flat mounting area of the flat die magnetic holding base, the die pattern comprising a pattern of lands and blades extending from the front surface, the metallic, flat die further comprising at least two through-holes formed therethrough, wherein the at least two alignment pins of the flat die magnetic die holding base extend respectively into the at least two through-holes of the metallic, flat die to align the metallic, flat die with the flat mounting area.

3. The assembly of claim 2, wherein the metallic, flat die comprises a milled metal plate.

4. The assembly of claim 3, wherein the metallic, flat die comprises a chemically etched metal plate.

5. The assembly of claim 3, wherein the metallic, flat die comprises a mechanically milled metal plate.

6. The assembly of claim 2, wherein the at least two alignment pins consists of three alignment pins and the at least two through-holes of the metallic, flat die consists of three through-holes.

7. The flat die magnetic holding base of claim 1, wherein:
the metal plate has a rectangular shape, two sides that are parallel to each other, and two parallel edge areas formed in the front surface adjacent the two sides, respectively;
each of the two parallel edge areas comprises a step and a landing;
the metal plate has a first thickness at the flat mounting area;
each landing has a second thickness; and
the second thickness is less than the first thickness.

8. The flat die magnetic holding base of claim 7, wherein, in each landing, a metal die rule retaining slot is formed, and the magnetic die-holding base further comprises:
a plurality of metal die rule holding magnet recesses formed in the back surface of the metal plate, including at least one metal die rule holding magnet recess adjacent each metal die rule retaining slot; and
a plurality of second magnets, including a second magnet permanently fixed in each metal die rule holding magnet recess, wherein each of the second magnets is arranged in an orientation such that a second magnetic field is generated that magnetically holds a metal die rule in the respective adjacent metal die rule retaining slot, and the second magnetic field is oriented perpendicularly relative to the first magnetic field.

9. The flat die magnetic holding base of claim 8, further comprising a plurality of metal die rules, including a respective metal die rule in each metal die rule retaining slot.

10. The flat die magnetic holding base of claim 8, wherein each of the first magnets has a flat surface, the flat surfaces of the first magnets are all arranged parallel to one another, each of the second magnets has a flat surface, and the flat surfaces of the second magnets are oriented perpendicularly with respect to the flat surfaces of the first magnets.

11. The flat die magnetic holding base of claim 8, wherein the first magnets are neodymium magnets and the second magnets are neodymium magnets.

12. The flat die magnetic holding base of claim 7, wherein each landing comprises two through-hole bushings, two roll pins each held by friction in a respective one of the two through-hole bushings, the flat die magnetic holding base is combined with a counterplate having counterplate through-holes, and each roll pin is held by friction in a respective one of the counterplate through-holes.

13. The flat die magnetic holding base of claim 1, wherein each of the first magnets is disk shaped and permanently fixed in a respective one of the first recesses by a hardened epoxy.

14. The flat die magnetic holding base of claim 1, wherein the base comprises aluminum.

15. The flat die magnetic holding base of claim 1, wherein the at least two alignment pins are received in respective alignment pin through-holes formed in the metal plate, wherein each of the at least two alignment pins has an outer diameter, each of the alignment pin through-holes has an inner diameter, and the outer diameter and the inner diameter are the same.

16. The flat die magnetic holding base of claim 1, wherein the first magnets are neodymium magnets.

17. A method of making the assembly of claim 2, comprising:
providing the flat die magnetic holding base;
providing the metallic, flat die; and
placing the metallic, flat die on the flat mounting area such that (1) the flat die magnetic holding base magnetically holds the metallic, flat die, and (2) the at least two alignment pins extend from the flat die magnetic holding base into the at least two through-holes of the metallic, flat die.

18. The method of claim 17, further comprising:
removing the metallic, flat die from the flat mounting area; and then
placing a different metallic, flat die, having at least two through-holes, on the flat mounting area such that (1) the flat die magnetic holding base magnetically holds the different metallic, flat die, and (2) the at least two alignment pins extend from the flat die magnetic holding base into the at least two through-holes of the different metallic, flat die.
